(19) United States
(12) Patent Application Publication
(10) Pub. No.: US 2014/0351689 A1
(43) Pub. Date: Nov. 27, 2014

(54) METHODS AND SYSTEMS FOR DISPLAYING WEBPAGE CONTENT

(71) Applicant: UC MOBILE LIMITED, Beijing (CN)

(72) Inventor: Jie Liang, Guangzhou (CN)

(21) Appl. No.: 14/344,389

(22) PCT Filed: Dec. 26, 2012
(86) PCT No.: PCT/CN2012/087522

§ 371 Date: Mar. 12, 2014

(30) Foreign Application Priority Data
Feb. 28, 2012 (CN) 201210048961.0

(51) Int. Cl. G06F 17/22

(52) U.S. Cl. CPC G06F 17/2247
USPC 715/234

(57) ABSTRACT

A method and system for displaying webpage content are disclosed. The method for displaying webpage content includes determining a center of a zoom after receiving an instruction to scale a webpage; determining a position of the center of the zoom in a node region of the webpage; and scaling the webpage according to the instruction to scale. The method further includes determining a first set of coordinates reflecting a position of the center of the zoom after the scaling process; setting a browser window based on the position of the center of the zoom; and determining a second set of coordinates reflecting a position of the browser window in relation to the webpage. The method also includes displaying webpage content based on the second set of coordinates. The system for displaying webpage content enables users to scale a webpage while maintaining the same viewing center before and after the scaling process.

### CROSS-REFERENCES TO RELATED APPLICATIONS

### Related Applications

This application is based upon and claims the benefit of priority from Chinese Patent Application No. 201210048961.0, filed on Feb. 28, 2012, the entire contents of which are incorporated herein by reference.

### FIELD OF THE INVENTION

The present disclosure relates to mobile communication technologies and, more particularly, to methods and systems for displaying webpage content on mobile terminal and devices.

### BACKGROUND

Web users can scale a webpage in various browser windows. By using the scaling function, a user may zoom-in or zoom-out on a webpage. Often, when a user changes the scale of a webpage, the format of the webpage display may adjust to the new scale. Before and after the scaling process, the viewing area of the webpage displayed in the browser window may shift to a different area of the webpage. In particular, for mobile devices with smaller screen sizes, scaling a webpage may cause a significant shift of the viewing area. As a result, after scaling the webpage, the user may need to move around on the webpage to find the viewing area that was in focus before the scaling process.

The disclosed method and system are directed to solve one or more problems set forth above and other problems.

### BRIEF SUMMARY OF THE DISCLOSURE

Embodiments consistent with the present disclosure provide a method, system, mobile terminal, or a server for displaying webpage content. Embodiments consistent with the present disclosure provide improved user experience when a user scales a webpage.

One aspect of the present disclosure provides a method for displaying webpage content. The method for displaying webpage content includes the steps of determining a center of the zoom after receiving an instruction to scale a webpage; determining a position of the center of the zoom in a node region of the webpage; and scaling the webpage according to the instruction to scale. The method further includes the steps of determining a first set of coordinates reflecting a position of the center of the zoom after the scaling process; setting a browser window based on the center of the zoom; and determining a second set of coordinates reflecting a position of the browser window in relation to the webpage. The method also includes the step of displaying webpage content based on the second set of coordinates.

In embodiments consistent with the present disclosure, the method for displaying webpage content may further include the steps of setting the browser window using the center of the zoom as the center of the browser window and determining the second set of coordinate (X2, Y2) as follows:

X2=Xf−W/2;

Y2=Yf−H2/2;

wherein (X2, Y2) refer to a position of a top left corner of the browser; (Xf, Yf) are the first set of coordinates; W is a width of the browser window; and H is a height of the browser window.

In embodiments consistent with the present disclosure, the method for displaying webpage content may further include the steps of determining the position of the center of the zoom in a corresponding node region before the scaling process by obtaining a third set of coordinates (Xp1, Yp1); and obtaining coordinates reflecting a position of the node region (Xn, Yn)(Wn, Hn), wherein (Xn, Yn) is a position of a left top corner of the node region before the scaling process; Wn is the width of the node region before the scaling process; and Hn is the height of the node region before the scaling process.

In embodiments consistent with the present disclosure, the method for displaying webpage content may further include determining the position of the center of the zoom in the node region and determining a proportional position of the center of the zoom in the node region as follows:

PercentX=(Xp1−Xn)/Wn;

PercentY=(Yp1−Yn)/Hn;

wherein PercentX is the proportional value of the center of the zoom on the X-axis and PercentY is the proportional value of the center of the zoom on the on the Y-axis.

In embodiments consistent with the present disclosure, the method for displaying webpage content may further include the step of determining a position of the node region after the scaling process by obtaining coordinates (Xm, Ym) (Wm, Ym), wherein (Xm, Ym) is a position of the left top corner of the node region; Wm is the width of the node region; and Hm is the height of the node region. Further, the method may include determining the second set of coordinates as follows:

X2=Xm+PercentX*Wm−W/2;

Y2=Ym+PercentY*Hm−H/2;

wherein (X2, Y2) is a position of the left top corner of the browser window; W is the width of the browser window; and H is the height of the browser window.

Another aspect of the present disclosure provides a system for displaying webpage content. The system includes a first obtaining module configured to obtain a position of a center of the zoom after receiving an instruction to scale a webpage; a fourth obtaining module configured to obtain a position of the center of the zoom in a node region of the webpage; a second obtaining module configured to obtain the webpage according to the instruction to scale and to determine a first set of coordinates reflecting position of the center of the zoom after the scaling process; and a third obtaining module configure to set a browser window based on the center of the zoom and to determine a second set of coordinates reflecting the position of the browser window in relation to the webpage. The system for displaying webpage content may further include a display module configured to display webpage content based on the second set of coordinates.

In embodiments consistent with the present disclosure, the third obtaining module may be further configured to set the browser window using the center of the zoom as the center of the browser window. Further, the third obtaining module may be further configured to determine the second set of coordinate (X2, Y2) as follows:

X2=Xf−W/2;

Y2=Yf−H2/2;

wherein (X2, Y2) refer to a position of a top left corner of the browser; (Xf, Yf) are the first set of coordinates; W is a width of the browser window; and H is a height of the browser window.

In embodiments consistent with the present disclosure, the fourth obtaining module may further include a first obtaining unit configured to determine a position of the center of the zoom in a corresponding node region before the scaling process by obtaining a third set of coordinates (Xp1, Yp1); and a position determination unit configured to obtain coordinates reflecting a position of the node region (Xn, Yn)(Wn, Hn), wherein (Xn, Yn) is a position of a left top corner of the node region before the scaling process; Wn is the width of the node region before the scaling process; and Hn is the height of the node region before the scaling process.

In embodiments consistent with the present disclosure, the second obtaining module may be further configured to determine the position of the center of the zoom in the node region may further include determining a proportional position of the center of the zoom in the node region as follows:

PercentX=(Xp1−Xn)/Wn,

PercentY=(Yp1−Yn)/Hn,

wherein PercentX is the proportional value of the center of the zoom on the X-axis and PercentY is the proportional value of the center of the zoom on the on the Y-axis.

In embodiments consistent with the present disclosure, the second obtaining module may be further configured to determine a position of the node region after the scaling process by obtaining coordinates (Xm, Ym) (Wm, Ym), wherein (Xm, Ym) is a position of the left top corner of the node region; Wm is the width of the node region; and Hm is the height of the node region.

In embodiments consistent with the present disclosure, the third obtaining module may be further configured to determine the second set of coordinates as follows:

X2=Xm+PercentX*Wm−W/2;

Y2=Ym+PercentY*Hm−H/2;

wherein (X2, Y2) is a position of the left top corner of the browser window; W is the width of the browser window; and H is the height of the browser window.

Additionally, in embodiments consistent with the present disclosure, the node region is a predetermined area of the webpage corresponding to a text node or a graphics node. The instruction to scale the webpage may be received through a multi-touch screen. The center of the zoom may be the center of multiple touch points. The instruction to scale the webpage may also be received through a zoom button. The center of the zoom may be the center of the webpage display.

The method and system for displaying webpage content enable users to scale a webpage display while maintaining the same viewing center before and after the scaling process. Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for displaying webpage content implemented by an exemplary embodiment consistent with the present disclosure;

FIG. 2 is another flowchart of a method for displaying webpage content implemented by an exemplary embodiment consistent with the present disclosure;

FIG. 3 is a block diagram of an exemplary system for displaying webpage content consistent with the present disclosure;

FIG. 4 is another block diagram of an exemplary system for displaying webpage content consistent with the present disclosure;

FIG. 5 is a block diagram of an exemplary obtaining module of a system for displaying webpage content consistent with the present disclosure;

FIG. 6 is an exemplary webpage consistent with the present disclosure;

FIG. 7 is another exemplary webpage consistent with the present disclosure;

FIG. 8 is another exemplary webpage consistent with the present disclosure;

FIG. 9 is another exemplary webpage consistent with the present disclosure;

FIG. 10 is another exemplary webpage consistent with the present disclosure; and

FIG. 11 is another exemplary webpage consistent with the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

In the present disclosure, the size of the webpage may be the size of the whole webpage. The size of the window may be the size of the browser window. The position of the window may be defined by the top left corner of the browser window in relation to the complete webpage. Coordinates (X, Y) may be the X-axis value and Y-axis value of a point. The position of a region of a webpage may be defined as (X, Y), (W, H), wherein X and Y may be the values of the X-axis and Y axis of the left top corner of the region; and W may be the width of the region, and H may be the height of the region.

### First Embodiment

The present disclosure teaches a method for displaying webpage content. Using this method, a system for displaying webpage content may maintain the same viewing area through a scaling process and thus provide a more consistent user browsing experience. As a result, the user of the system may not need to manually move around the webpage after the scaling process.

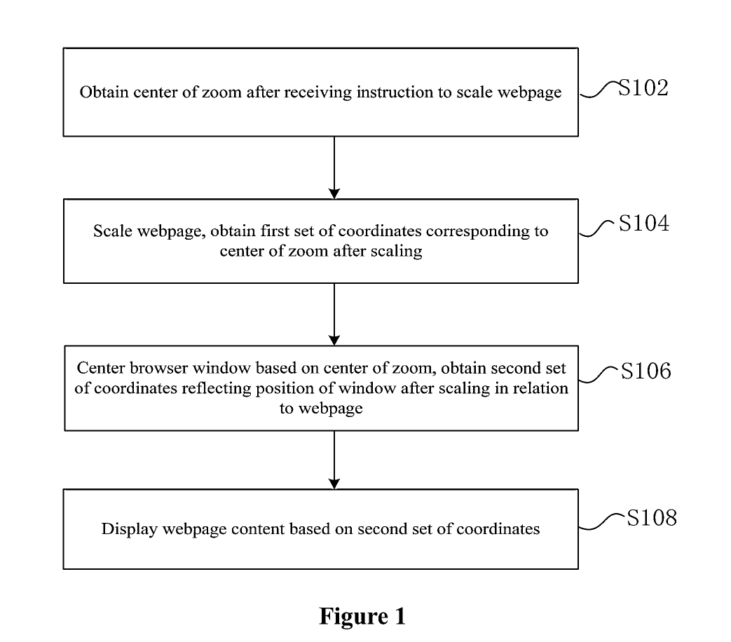

FIG. 1 shows a flow chart of a method for displaying webpage content consistent with the present disclosure. The method shown in FIG. 1 includes steps S102-S108. In step S102, after receiving an instruction to scale a webpage, a system for displaying webpage content may obtain data related to the center of the scaling (i.e., zoom). In step S104, the system may scale the webpage according to the instruction. The system may obtain a first set of coordinates reflecting the post scaling position of the center of the zoom (obtained in step 102).

In step S106, the system may then set the center of the zoom after the scaling process as the center of the area displayed in the browser window after the scaling process. The system may obtain a second set of coordinates reflecting the relationship between the displayed area of the webpage after the scaling process and the whole webpage. In step S108, the system may display the webpage content in the browser window after the scaling process based on the second set of coordinates.

Embodiments consistent with the present disclosure may receive instructions by a user to scale a webpage. The system may obtain the data related to the center of the scaling. After scaling the webpage, the system may obtain a first set of coordinates that reflect the center of the scaling in relation to the webpages. The system may set the center of the browser window using the center of the scaling after the scaling process. The system may further obtain a second set of coordinates that reflect the relationship between the webpage and the area of the webpage in the browser window after the scaling process.

Embodiments consistent with the present disclosure may enable users to scale a webpage display using touch sensitive displays or displays controlled by other input mechanisms such as zoom buttons. Further, embodiments consistent with the present disclosure may select different centers for the zooms.

In one embodiment consistent with the present disclosure, the system for displaying webpage content may implement the following steps. (1) The user may use a touch screen display to input a request to scale a webpage. The system may receive the instructions, and then obtain the position of the center of the zoom. This step may further include receiving a user's input to scale the webpage display through a touch screen display and setting the center of the zoom based on the center of the touch points of the user. (2) The user may use zoom buttons to input a request to scale the display of a webpage. The system may receive the instructions, and then obtain the position of the center for the scaling. This step may further include receiving a user's input to scale the webpage display through zoom buttons and setting the center of the scaling based on the center of the display window.

After receiving the instruction to scale the webpage, the system may obtain the position of the center for the scaling and then execute the scaling process. The system may then obtain the first set of coordinates (Xf, Yf), wherein (Xf, Yf) indicate the position of the center of the zoom (before the scaling process) after the scaling process in relation to the webpage. After obtaining the first set of coordinates, the system may set the center of the area displayed in the browser window after the scaling process using the center of the zoom. The system may then adjust the area displayed in the browser window based on the area viewed by the user before the scaling process. The system may set the center of display area after a scaling process using the center of the zoom after the scaling. The system may obtain a second set of coordinates reflecting the position of the browser window relative to the original webpage. For example, the second set of coordinates may be:

X2=Xf−W/2;

Y2=Yf−H/2;

wherein (X2, Y2) are the coordinates of the position of the left top corner of the browser window; (Xf, Yf) are the first set of coordinates (the relative position of the center of the zoom after the scaling process); W is the width of the browser window; and H is the height of the browser window.

In addition, to place the viewing area before the scaling process properly in the browser window, the system may first define a node region of the webpage corresponding to the center of the zoom. The system may obtain the relative position of the center of the zoom in the node region. The system may further adjust the browser window after the scaling process based on the relative position.

In embodiments consistent with the present disclosure, the system for displaying webpage content may obtain the relative position of the center of the zoom in its corresponding node region. For example, the step of obtaining a first set of coordinates would be obtaining the coordinates reflecting the position of the node region after the scaling process. After obtaining the first set of coordinates and based on the relative position and the position of the node region after the scaling process, the system may obtain the second set of coordinates.

In one embodiment consistent with the present disclosure, the system for displaying webpage content may implement the following steps to obtain the position of the node region after the scaling process. In step 1, the system may obtain a third set of coordinates reflecting the position of the center of the zoom before the scaling process (Xp1, Yp1). In step 2, based on the third set of coordinates, the system may locate the node region of the webpage corresponding to the center of the zoom. In step 3, the system may obtain the coordinates of the node region (Xn, Yn) (Wn, Hn), wherein (Xn, Yn) is the coordinates of the left top corner of the node region before the scaling process, Wn is the width of the node region before the scaling process, and Hn is the height of the node region before the scaling process. In step 4, based on the third set of coordinates and the coordinates of the node region, the system may obtain the position of the center of the node region, wherein the position may be defined by a PercentX in the horizontal direction and a PercentY in the vertical direction as follows:

PercentX=(Xp1−Xn)/Wn,

PercentY=(Yp1−Yn)/Hn.

The system for displaying webpage content may obtain the position of the node region after the scaling process (Xm, Ym) (Wm, Hm), wherein (Xm, Ym) are the coordinates of the left top corner of the node region, Wm is the width of the node region, and Hm is the height of the node region.

Based on the proportional values and position of the node region after the scaling process, the system for displaying webpage content may determine the second set of coordinates as follows:

X2=Xm+PercentX*Wm−W/2;

Y2=Ym+PercentY*Hm−H/2;

wherein, (X2, Y2) are the position of the left top corner of the browser window; W is the width of the window; and H is the height of the window.

After determining the second set of coordinates, the system for displaying webpage content may adjust the browser window using the second set of coordinates (X2, Y2). The system may move the browser window to display the node region (and therefore display the webpage) after the scaling process. As a result, the system may center the screen display after the scaling process around the node region.

In embodiments consistent with the present disclosure, a node region may be a pre-determined text region or a graphics region of a webpage.

### Second Embodiment

Embodiments consistent with the present disclosure enable users to scale a webpage by using a multi-touch screen or clicking zoom buttons. The system may then reformat the webpage and re-center the webpage to display the part of webpage that was being viewed by the user before the scaling process. Embodiments consistent with the present disclosure may eliminate the need for manual adjustment of the webpage after the scaling process.

For example, if a smartphone has a browser window with a width of W, and height of H, and the position of the window (in relation to the webpage) is (X1, Y1), the scale of the webpage display before the scaling process may be Z1. After a user scales the webpage, which may be through a multi-touch screen or a scaling button, the scale of the webpage display may be Z2. In the second embodiment described below, the scaling means may be a two-touch-point screen.

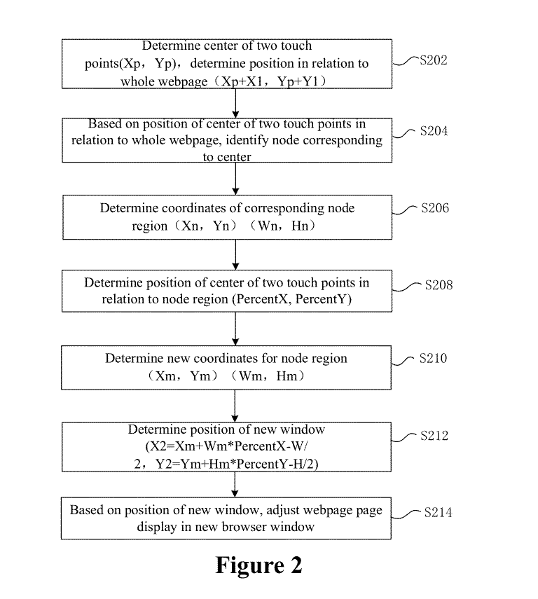

FIG. 2 is a flow chart of a method implemented by the second embodiment consistent with the present disclosure. The method shown in FIG. 2 includes steps S202-S214. In step S202, the system may calculate the center of the two touch points (Xp, Yp). The system may determine that center of the coordinates of the two touch points in relation to the webpage (Xp1, Yp1) equal to (Xp+X1, Yp+Y1).

The system may receive the user's input to scale the webpage. The system may then determine the center of the two touch points (Xp, Yp) as described below. The system may determine the coordinates of the two touch points as (Xa, Ya) and (Xb, Yb). The system may determine that Xp=(Xa+Xb)/2, Yp=(Ya+Yb)/2.

In step S204, the system may determine the node of the webpage corresponding to the position (Xp1, Yp1). In step S206, based on the node identified in step S204, the system may determine the coordinates of the corresponding node region (Xn, Yn) (Wn, Hn), wherein Xn is the X axis value for the top left corner of the node region before the scaling process; Yn is the Y axis value for the top left corner of the node region before the scaling process; Wn is the width of the node region before the scaling process; and Hn is the height of the node region before the scaling process.

The method to determine a node region may be specific to languages and standards used to describe the webpage, such as the HTML4.1 and CSSS2.1 standards. For example, based on the language/format of the webpage, the system may identify a node (e.g., a text node or a graphics node) using the DOM specifications. Once the system identifies a relevant node, the system may identify the region of the webpage corresponding to the node (i.e., the node region). The node region may be described by an X-axis value, a Y-axis value, a width, and a height. As such, the system for display webpage contents may identify the coordinates for a node region.

In step S208, the system may determine the position of the center of the two touch points in relation to the node region. The system may determine that horizontally, Percent X=(Xp1−Xn)/Wn, a vertically Percent Y=(Yp1−Yn)/Hn. In step S210, the system may scale the webpage and reformat the scaled webpage. Because the width of the screen display may be different, the format of the webpage may be adjusted accordingly. For the new webpage display, the system may determine the new coordinates corresponding to the position of the node region (Xm, Ym) (Wm, Hm).

The system for displaying webpage content may scale a webpage (e.g., through a two-touch-point motion) in response to the user's scaling instruction. The system may store the data described above before it scales and reformats the webpage.

The method used to determine the new node region coordinates is similar to the method described in step S206.

In step S212, based on the proportional measures determined in step S208, and the width and height of the browser window, the system may determine the position of the new window. For example, the position of the new browser window after the scaling process may be determined as (X2, Y2), wherein X2=Xm+Wm*PercentX−W/2; and Y2=Ym+Hm*PercentY−H/2.

In step S214, the system may adjust the webpage display based the position (X2, Y2). (X2, Y2) may be the position of the browser window. Based on the calculated browser window position, the system may set the browser window to that position, and then reformat the webpage contents displayed in the window. As such, the system may set the content viewed by the user to the center of the browser window and therefore maintain a consistent browsing experience before and after the scaling process.

Embodiments consistent with the present disclosure may implement the above steps to automatically align the webpage after the scaling process. The above embodiment is an example of a scaling request received through a multi-touch screen. When a user clicks a scaling button on a user interface, there is no “center of two touch point.” The system for displaying webpage content may implement steps similar to those described above. Further, in step S202, the coordinates (Xp, Yp) would not be the center of the two touch points. Instead (Xp, Yp) would be the center of the screen display (the center of the window). That is, Xp=W/2; and Yp=H/2. The other steps would be the same.

### Third Embodiment

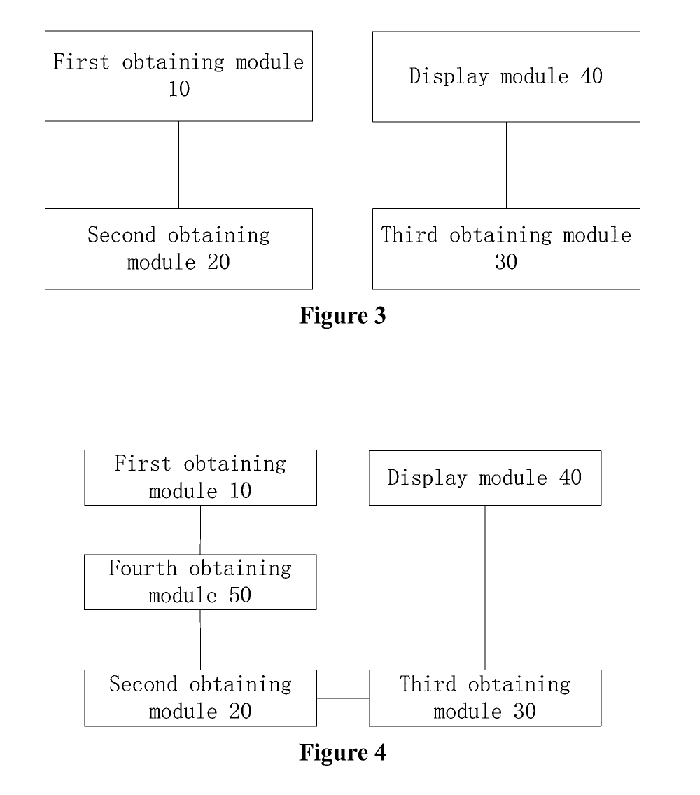

Embodiments consistent with the present disclosure further provide an apparatus for displaying webpage content. FIG. 3 shows a block diagram of an exemplary apparatus for displaying webpage content consistent with the present disclosure. The apparatus shown in FIG. 3 may include a first obtaining module 10, a second obtaining module 20, a third obtaining module 30, and a display module 40.

The first obtaining module 10 may receive a scaling request from a user. The first obtaining module 10 may obtain the position of the center for the scaling. The second obtaining module 20 may be connected to the first obtaining module 10. The second obtaining module 20 may obtain a first set of coordinates reflecting the position of the center of the zoom after the scaling process in relation to the webpage. The third obtaining module 30 may be connected with the second obtaining module 20. The third obtaining module 30 may center the browser window based on the center of the zoom after the scaling process. The third obtaining module 30 may, based on the first set of coordinates, further obtain a second set of coordinates reflecting the relative position of the browser window after the scaling process in relation to the whole webpage. The display module 40 may be connected to the third obtaining module 30. The display module 40 may set the browser window using the second set of coordinates and display the webpage in the browser window (after the scaling process).

Embodiments consistent with the present disclosure may receive instructions by a user to scale a webpage. The system may obtain the data related to the center of the zoom. After scaling the webpage, the system may obtain a first set of coordinates that reflect the center of the zoom in relation to the webpages. The system may set the center of the browser window using the center of the zoom after the scaling process. The system may further obtain a second set of coordinates reflecting the relationship between the webpage and the area of the webpage in the browser window after the scaling process. The system may display the webpage based on the second set of coordinates. The system may then reformat the webpage and re-center the webpage to display the part of webpage that was viewed by the user before the scaling process. Embodiments consistent with the present disclosure may deliver a consistent browsing experience and avoid the step of manual adjustment of the webpage after the scaling process by the user. Embodiments consistent with the present disclosure therefore may improve a user's browsing experience.

Embodiments consistent with the present disclosure may enable users to scale a webpage display using touch sensitive displays or displays controlled by inputs from zoom buttons. According to different operations of the scaling process, embodiments consistent with the present disclosure may select different center for the requested scaling.

In one embodiment consistent with the present disclosure, a user may use a touch screen display to input a request to scale the display of a webpage. The first obtaining module 10 may receive the instructions, and then obtain the position of the center of the scaling. This step may further include receiving a user's input to scale the webpage display through a touch screen display and setting the center of the scaling based on the center of the touch points by the user. In the case that the user may use zoom buttons to input a request to scale the display of a webpage, the first obtaining module 10 may receive the instructions, and then obtain the position of the center for the scaling. This step may further include receiving a user's input to scale the webpage display through zoom buttons and setting the center of the zoom based on the center of the display window.

After receiving the instruction to scale the webpage, the system for displaying webpage content may obtain the position of the center for the zoom and then execute the scaling steps. The second obtaining module 20 may then obtain the first set of coordinates (Xf, Yf), wherein (Xf, Yf) indicate the center of the zoom after the scaling process in relation to the webpage.

After obtaining the first set of coordinates, the system may set the center of the area displayed in the browser window after the scaling process using the center of the zoom. The system may then adjust the area displayed in the browsing window based on the area viewed by the user before the scaling process. The system may set the center of the displayed area after the scaling process using the center of the zoom after the scaling process. The third obtaining module 30 may obtain a second set of coordinates reflecting the position of the browser window relative to the original webpage. For example, the second set of coordinates may be:

X2=Xf−W/2;

Y2=Yf−H/2;

wherein (X2, Y2) indicate the position of the left top corner of the browser window; (Xf, Yf) are the first set of coordinates (the relative position of the center of the zoom after the scaling process); W is the width of the browser window; and H is the height of the browser window.

In addition, to place the viewing area before the scaling process properly in the browser window, the system may first identify a webpage node region of the webpage corresponding to the center of the zoom. The system may obtain the relative position of the center of the zoom in the node region. The system may further adjust the browser window after the scaling process based on the relative position in the node region.

In one embodiment consistent with the present disclosure, as shown in FIG. 4, an exemplary apparatus may include a fourth obtaining module 50. The fourth obtaining module 50 may be connected to the first obtaining module 10. The fourth obtaining module 50 may obtain the relative position of the center of the zoom in its corresponding node region.

The second obtaining module 20 may further obtain the coordinates reflecting the position of the node region after the scaling process. After obtaining the first set of coordinates and based on the position of the node region after the scaling process, the third obtaining module 30 may obtain the second set of coordinates.

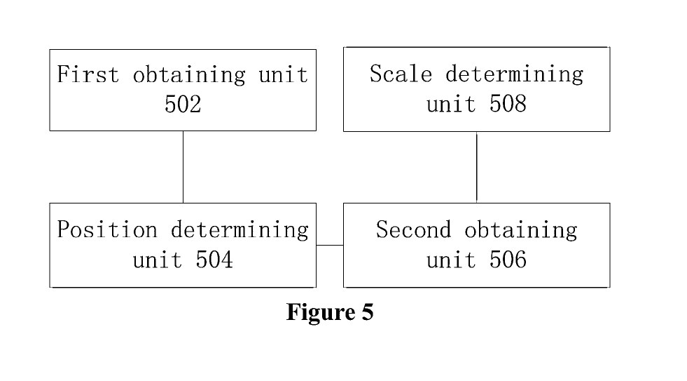

In one embodiment consistent with the present disclosure, as shown in FIG. 5, the fourth obtaining module 40 may include a first obtaining unit 502, a position determination unit 504, a second obtaining unit 506, and a scale determination unit 508. The first obtaining unit 502 may obtain a third set of coordinates reflecting the position of the center of the zoom before the scaling process (Xp1, Yp1). Based on the third set of coordinates, the position determination unit 504 may identify the node region of the webpage corresponding to the center of the zoom. The second obtaining unit 506 may obtain the coordinates of the node region (Xn, Yn) (Wn, Hn), wherein (Xn, Yn) are the coordinates of the left top corner of the node region before the scaling process; Wn is the width of the node region before the scaling process; and Hn is the height of the node region before the scaling process. Based on the third set of coordinates and the coordinates of the node region, the scale determination unit 508 may obtain the position of the center in the node region, wherein the position may be defined by a PercentX in the horizontal direction and a PercentY in the vertical direction as follows:

PercentX=(Xp1−Xn)/Wn,

PercentY=(Yp1−Yn)/Hn.

Further, the second obtaining module 20 may obtain the position of the node region after the scaling process in relation to the webpage, (Xm, Ym) (Wm, Hm), wherein (Xm, Ym) are the coordinates of the left top corner of the node region in relation to the webpage; Wm is the width of the node region; and Hm is the height of the node region.

Based on the proportional position of the center of the zoom in the node region and the position of the node region after the scaling process, the third obtaining module 30 may determine the second set of coordinates as follows:

X2=Xm+Percent X*Wm−W/2;

Y2=Ym+Percent Y*Hm−H/2;

wherein (X2, Y2) refer to the position of the left top corner of the browser window; W is the width of the window; and H is the height of the window.

Embodiments consistent with the present disclosure may further provide a browser and/or an apparatus implementing methods for displaying webpage content, as described above. Embodiments consistent with the present disclosure may further provide a portable electronic device, such as a mobile terminal, including the devices used in the embodiments described above.

Embodiments consistent with the present disclosure may implement the as described steps to automatically align the webpage after the scaling process and improve user experience. The two examples below further describe the system for displaying webpage content.

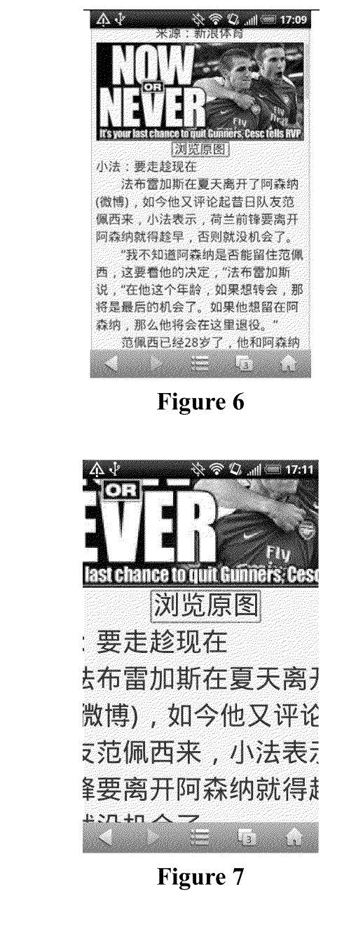

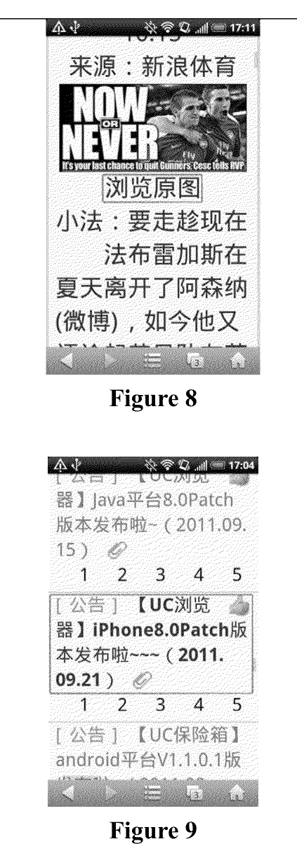

FIG. 6 shows a WAP webpage rendering before a webpage is enlarged. A user may enlarge the webpage shown in FIG. 6 using a multiple touch point display. The center of the zoom is located at “ [symbol] ” in the original webpage display. After the webpage is enlarged, as shown in FIG. 7 (FIG. 7 shows an enlarged version of the webpage in FIG. 6), applying the method consistent with the present disclosure, the system may reformat the webpage, adjust the position of the browser window. The system may align “ [symbol] ” to the center of the browser window, as shown in FIG. 8. FIG. 8 shows the rendering of the WAP webpage after the scaling process (enlargement) and with the center aligned to the center for the scaling.

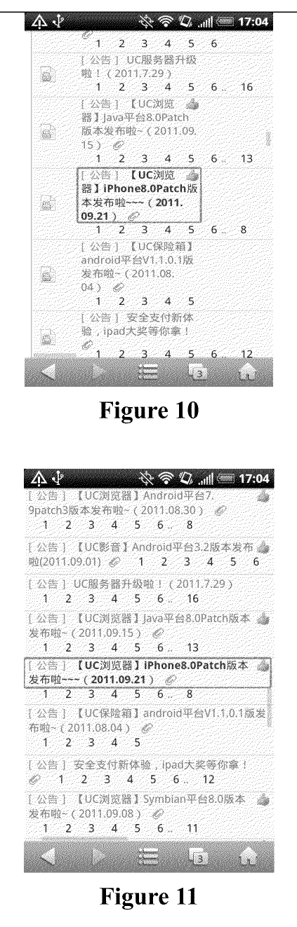

FIG. 9 shows a rendering of a WWW webpage before a scaling process (zooming out). A user may zoom out on the webpage shown in FIG. 9 using a multi-touch screen. The center of the zoom is located at the paragraph entitled “UC [symbol] .” After the user zooms out, as shown in FIG. 10 (FIG. 10 shows a reduced sized version of the webpage), applying the method consistent with the present disclosure, the system may reformat the webpage, adjust the position of the browser window. For example, the system may align the paragraph “UC [symbol] ” to the center of the browser window, as shown in FIG. 11. FIG. 11 shows the rendering of the WWW webpage after the scaling process (zoom out) and with the center of the zoom aligned with the center of the browser window.

Embodiments consistent with the present disclosure may receive instructions by a user to scale a webpage. The system may obtain the data related to the center of the scaling (the center of the zoom). After scaling the webpage, the system may obtain a first set of coordinates reflecting the center of the scaling in relation to the webpages. The system may set the center of the browser window using the position of the center of the zoom after the scaling process. The system may further obtain a second set of coordinates reflecting the relationship between the webpage and the area of the webpage displayed in the browser window after the scaling process. The system may display the webpage based on the second set of coordinates. The system may then reformat the webpage and re-center the webpage to display the part of webpage that was being viewed by the user before the scaling process. Embodiments consistent with the present disclosure may deliver a consistent browsing experience and eliminate the step of manual adjustment of the webpage after the scaling process by the user. Embodiments consistent with the present disclosure therefore may improve a user's browsing experience.

Consistent with embodiments of the present disclosure, one or more non-transitory storage medium storing a computer program are provided to implement the system and method for displaying webpage content. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A method for displaying webpage content, comprising:
determining a center of a zoom after receiving an instruction to scale a webpage;
determining a position of the center of the zoom in a node region of the webpage;
scaling the webpage according to the instruction to scale;
determining a first set of coordinates reflecting a position of the center of the zoom and coordinates reflecting a position of the node region after the scaling process;
setting a browser window based on the position of the center of the zoom;
determining a second set of coordinates reflecting a position of the browser window in relation to the webpage; and
displaying webpage content based on the second set of coordinates.

2. The method according to claim 1, further comprising:
setting the browser window using the center of the zoom as the center of the browser window.

3. The method according to claim 1, further comprising:
determining the position of the center of the zoom in a corresponding node region before the scaling process by obtaining a third set of coordinates (Xp1, Yp1).

4. The method according to claim 3, further comprising:
obtaining coordinates reflecting a position of the node region (Xn, Yn)(Wn, Hn) before the scaling process, wherein (Xn, Yn) is a position of a left top corner of the node region before the scaling process; Wn is the width of the node region before the scaling process; and Hn is the height of the node region before the scaling process.

5. The method according to claim 4, wherein determining the position of the center of the zoom in the node region further includes determining a proportional position of the center of the zoom in the node region as follows:
PercentX=(Xp1−Xn)/Wn,
PercentY=(Yp1−Yn)/Hn,
wherein Percent X is a proportional value of the center of the zoom on an X-axis; and Percent Y is a proportional value of the center of the zoom on a Y-axis.

6. The method according to claim 5, further comprising:
determining a position of the node region after the scaling process by obtaining coordinates (Xm, Ym) (Wm, Ym), wherein (Xm, Ym) is a position of a left top corner of the node region after the scaling process; Wm is the width of the node region after the scaling process; and Hm is the height of the node region after the scaling process.

7. The method according to claim 6, wherein determining the second set of coordinates further comprises determining the second set of coordinates as follows:
X2=Xm+PercentX*Wm−W/2;
Y2=Ym+PercentY*Hm−H/2;
wherein (X2, Y2) is a position of a left top corner of the browser window; W is the width of the browser window; and H is the height of the browser window.

8. The method according to claim 1, wherein the node region is a predetermined area of the webpage corresponding to a text node or a graphics node.

9. The method according to claim 1, wherein the instruction to scale the webpage is received through a multi-touch screen, and the center of the zoom is a center of multiple touch points.

10. The method according to claim 1, wherein the instruction to scale the webpage is received through a zoom button, and the center of the zoom is the center of the browser window of the webpage.

11. An apparatus for displaying webpage content, comprising:
a first obtaining module configured to obtain a position of a center of a zoom after receiving an instruction to scale a webpage;
a fourth obtaining module configured to obtain a position of the center of the zoom in a node region of the webpage;
a second obtaining module configured to obtain a first set of coordinates reflecting position of the center of the zoom and coordinates reflecting a position of the node region after the scaling process;
a third obtaining module configure to set a browser window based on the position of the center of the zoom and to determine a second set of coordinates reflecting a position of the browser window in relation to the webpage; and
a display module configured to display webpage content based on the second set of coordinates.

12. The apparatus according to claim 11, wherein the third obtaining module is further configured to set the browser window using the center of the zoom as the center of the browser window.

13. The apparatus according to claim 11, wherein the fourth obtaining module further includes:
a first obtaining unit configured to obtain a position of the center of the zoom in a corresponding node region before the scaling process by obtaining a third set of coordinates (Xp1, Yp1).

14. The apparatus according to claim 11, wherein the fourth obtaining module further includes:
a position determination unit configured to obtain coordinates reflecting a position of the node region (Xn, Yn)(Wn, Hn) before the scaling process, wherein (Xn, Yn) is a position of a left top corner of the node region before the scaling process; Wn is the width of the node region before the scaling process; and Hn is the height of the node region before the scaling process.

15. The apparatus according to claim 14, wherein the second obtaining module is further configured to determine the position of the center of the zoom in the node region by determining a proportional position of the center of the zoom in the node region as follows:
PercentX=(Xp1−Xn)/Wn,
PercentY=(Yp1−Yn)/Hn,
wherein PercentX is a proportional value of the center of the zoom on an X-axis; and PercentY is a proportional value of the center of the zoom on a Y-axis.

16. The apparatus according to claim 15, wherein the second obtaining module is further configured to determine a position of the node region after the scaling process by obtaining coordinates (Xm, Ym) (Wm, Ym), wherein (Xm, Ym) is a position of a left top corner of the node region after the scaling process; Wm is the width of the node region after the scaling process; and Hm is the height of the node region after the scaling process.

17. The apparatus according to claim 16, wherein the third obtaining module is further configured to determine the second set of coordinates as follows:
X2=Xm+PercentX*Wm−W/2;
Y2=Ym+PercentY*Hm−H/2;
wherein (X2, Y2) is a position of a left top corner of the browser window; W is the width of the browser window; and H is the height of the browser window.

18. The apparatus according to claim 11, wherein the node region is a predetermined area of the webpage corresponding to a text node or a graphics node.

19. The apparatus according to claim 11, wherein the instruction to scale the webpage is received through a multi-touch screen, and the center of the zoom is a center of multiple touch points.

20. The apparatus according to claim 11, wherein the instruction to scale the webpage is received through a zoom button, and the center of the zoom is a center of the browser window of the webpage.
